(19) United States
(12) Patent Application Publication
(10) Pub. No.: US 2024/0096526 A1
(43) Pub. Date: Mar. 21, 2024

(54) MODULAR SURGE PROTECTOR

(71) Applicant: XIAMEN SET ELECTRONICS CO., LTD., Xiamen (CN)

(72) Inventors: Lianqiao YOU, Xiamen (CN); Anping CAO, Xiamen (CN); Xianggui ZHANG, Xiamen (CN)

(73) Assignee: XIAMEN SET ELECTRONICS CO., LTD., Xiamen (CN)

(21) Appl. No.: 17/767,924

(22) PCT Filed: Dec. 18, 2020
(86) PCT No.: PCT/CN2020/137723

§ 371 Date: Apr. 11, 2022

(30) Foreign Application Priority Data
Dec. 26, 2019 (CN) 201922387988.2

(51) Int. Cl. H01C 7/12; H01T 4/06; H02H 3/02

(52) U.S. Cl. CPC H01C 7/12; H01T 4/06; H02H 3/025

(57) ABSTRACT

A modular surge protector includes a shell, a discharge tube unit, a first varistor unit and a second varistor unit, where the discharge tube unit, the first varistor unit and the second varistor unit are arranged in the shell. The first varistor unit and the second varistor unit are stacked, the discharge tube unit is provided at a same side of each of the first varistor unit and the second varistor unit, a first electrode is led out from the first varistor unit, a second electrode is led out from the second varistor unit, and a third electrode is led out from the discharge tube unit. Three frames are provided for the discharge tubes and the varistors to form the modular design. With the vertical discharge tubes and the horizontal varistors, the modular surge protector has a compact structure and meets the requirements of miniaturization applications.

### CROSS REFERENCE TO THE RELATED APPLICATIONS

This application is the national phase entry of International Application No. PCT/CN2020/137723, filed on Dec. 18, 2020, which is based upon and claims priority to Chinese Patent Application No. 201922387988.2, filed on Dec. 26, 2019, the entire contents of which are incorporated herein by reference.

### TECHNICAL FIELD

The present invention provides a modular surge protector, and belongs to the technical field of lightning protection in the international patent classification (IPC).

### BACKGROUND

A surge protector is an electronic apparatus that provides safety protection for various electronic devices, instruments, and communication lines. It is intended to protect current or voltage spikes generated in electrical circuits or communication lines due to external interferences.

Because of restrictions of electronic components and so on, existing modular surge protectors are far from satisfactory to constant miniaturization of electronic products. Therefore, size optimization, reasonable spatial arrangement, greater ease of production and assembly, and higher reliability of the surge protector are problems of concern to a person skilled in the art.

### SUMMARY

In view of the defects in the prior art, an objective of the present invention is to provide a modular surge protector, which yields a compact structure and a small size through the modular design.

In order to achieve the above objective, the present invention employs the following technical solutions:

A modular surge protector includes a shell, a discharge tube unit, a first varistor unit and a second varistor unit, where the discharge tube unit, the first varistor unit and the second varistor unit are arranged in the shell. The first varistor unit and the second varistor unit are stacked, the discharge tube unit is provided at a same side of each of the first varistor unit and the second varistor unit, a first electrode is led out from the first varistor unit, a second electrode is led out from the second varistor unit, and a third electrode is led out from the discharge tube unit.

Further, the discharge tube unit may include a first discharge tube and a second discharge tube, the first varistor unit may include a first varistor, the first electrode may be led out from a positive electrode of the first varistor, the second varistor unit may include a second varistor, and the second electrode may be led out from a positive electrode of the second varistor;
the first discharge tube and the second discharge tube may be connected through a discharge tube common electrode, the discharge tube common electrode may be electrically connected to a back electrode of the first varistor, a back electrode of the second varistor may be connected to a back electrode of the second discharge tube, and the third electrode may be led out from the first discharge tube; and
the first electrode may be a phase electrode, the second electrode may be a grounding electrode, and the third electrode may be a neutral electrode.

Further, the first varistor unit may include a first frame and a first thermal trip, the first thermal trip and the first varistor may be respectively arranged at two sides of the first frame, and the first electrode may be led out from the positive electrode of the first varistor through the first thermal trip;
the second varistor unit may include a second frame and a second thermal trip, the second thermal trip and the second varistor may be respectively arranged at two sides of the second frame, and the second electrode may be led out from the positive electrode of the second varistor through the second thermal trip; and
the first varistor and the second varistor are arranged between the first frame and the second frame.

Further, the first varistor unit and the second varistor unit may be clamped by a clamping member.

Further, each of the first thermal trip and the second thermal trip may include a spring electrode, a sliding member and a compression spring, the spring electrode may be connected to a positive electrode of a corresponding varistor through a fusible alloy, and the spring electrode may abut against the sliding member and keep the compression spring in a compressed state; and in a failure state, the fusible alloy may be molten, the sliding member may slide along a guide track on the first frame or the second frame under an action of the compression spring such that the spring electrode may be isolated from the positive electrode of the corresponding varistor, and a side of the sliding member may extend outward to form an indication portion.

Further, the discharge tube unit may include a discharge tube frame; a first slot, a second slot and a third slot may be formed in the discharge tube frame, the first slot and the second slot may be provided side by side at a side of the discharge tube frame and respectively configured to accommodate the first discharge tube and the second discharge tube; the third slot may be provided at a side of the discharge tube frame and cooperate with an end portion of each of the first varistor unit and the second varistor unit; the first varistor unit and the second varistor unit may be horizontally stacked; and the first discharge tube and the second discharge tube may be vertically provided.

Further, the shell may include a shell body and an engageable cover plate, and the first electrode, the second electrode and the third electrode may be led out from a side of a cover plate to form a welding plate structure.

Three frames are provided for the discharge tubes and the varistors to form the modular design. With the vertical discharge tubes and the horizontal varistors, the present invention has the reasonable arrangement and compact structure, and meets the requirements of miniaturization applications.

The above description is merely a summary of the technical solutions of the present invention. In order to make the technical means of the present invention understood more clearly and implemented in accordance with the content of the specification, and in order to make the above and other objectives, features and advantages of the present invention more obvious and comprehensible, specific implementations of the present invention are described below.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic external view according to an embodiment of the present invention;

FIG. 2 is another schematic external view according to an embodiment of the present invention;

FIG. 3 is a schematic view of a structure without a shell according to an embodiment of the present invention;

FIG. 4 is an internal exploded view according to an embodiment of the present invention;

FIG. 5 is a schematic view of a first varistor unit according to an embodiment of the present invention;

FIG. 6 is an exploded view of FIG. 5;

FIG. 7 is a schematic view of a second varistor unit according to an embodiment of the present invention;

FIG. 8 is an exploded view of FIG. 7;

FIG. 9 is a schematic view of a discharge tube unit according to an embodiment of the present invention; and

FIG. 10 is a schematic circuit diagram according to an embodiment of the present invention.

### DETAILED DESCRIPTION OF THE EMBODIMENTS

To make the objectives, technical solutions, and advantages of the embodiments of the present invention clearer, the following clearly and completely describes the technical solutions of the embodiments of the present invention with reference to the accompanying drawings of the embodiments of the present invention. Apparently, the described embodiments are some but not all of the embodiments of the present invention. All other embodiments obtained by the person of ordinary skill in the art based on the embodiments of the present invention without creative efforts should fall within the protection scope of the present invention.

The present invention will be described in further detail below with reference to the accompanying drawings.

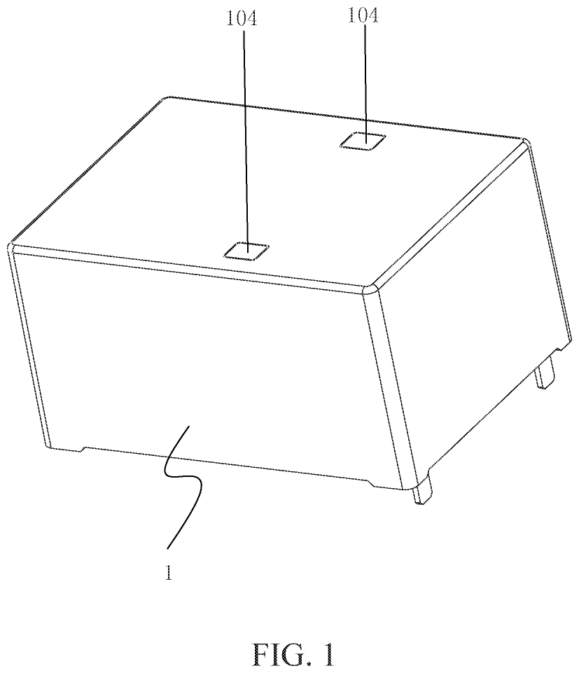

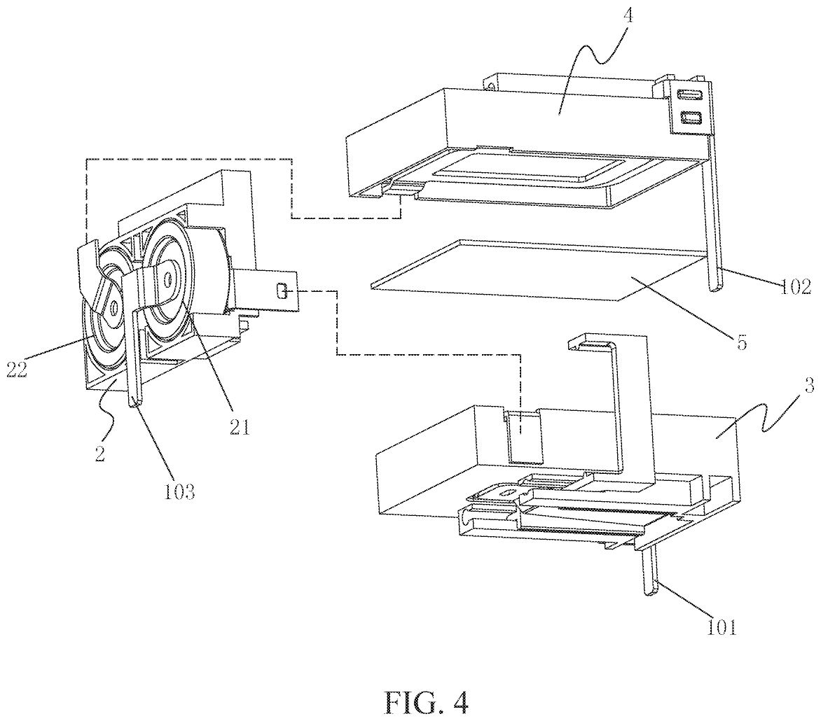

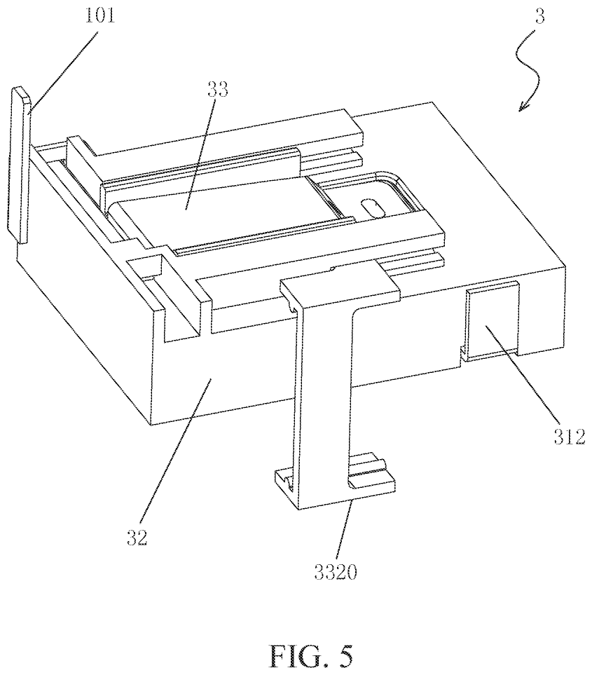

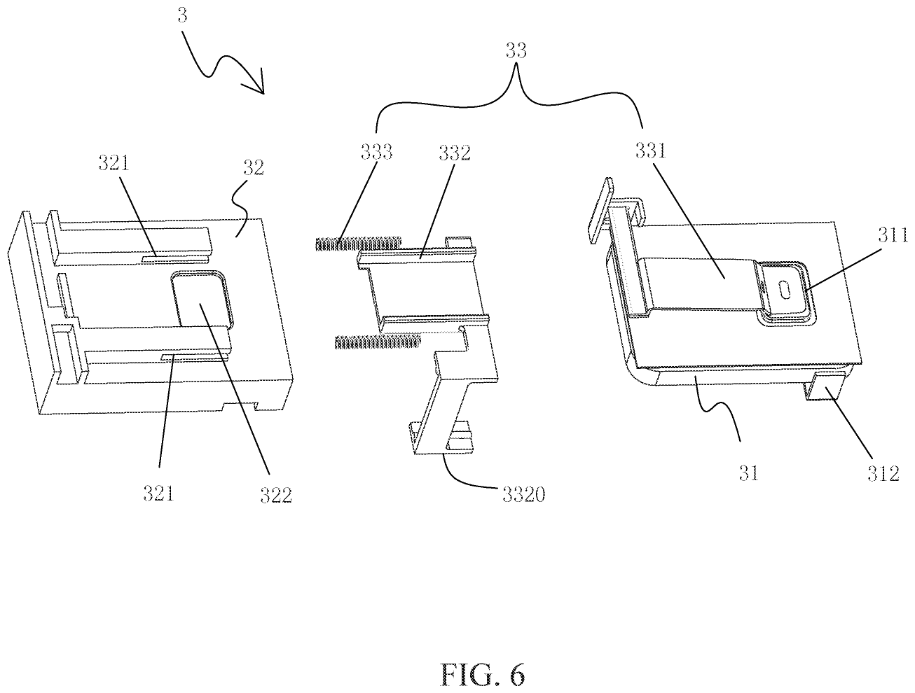

Embodiment: referring to FIG. 1 to FIG. 10, a modular surge protector includes a shell 1, a discharge tube unit 2, a first varistor unit 3 and a second varistor unit 4, where the discharge tube unit 2, the first varistor unit 3 and the second varistor unit 4 are arranged in the shell 1. The first varistor unit 3 and the second varistor unit 4 are stacked. The discharge tube unit 2 is provided at a same side of each of the first varistor unit 3 and the second varistor unit 4. A first electrode 101 is led out from the first varistor unit 3. A second electrode 102 is led out from the second varistor unit 4. A third electrode 103 is led out from the discharge tube unit 2. In the embodiment, the shell 1 includes a shell body 11 and an engageable cover plate 12. The first electrode 101, the second electrode 102 and the third electrode 103 are led out from a side of a cover plate 12 to form a welding plate structure. The first electrode is a phase electrode L, namely a live electrode. The second electrode is a grounding electrode PE. The third electrode is a neutral electrode N. Two indication windows 104 cooperated with an indication portion of an internal sliding member are formed in the shell body 11. Once tripped, the surge protector can give an indication with a corresponding color. Specifically, it turns green normally and turns red once tripped.

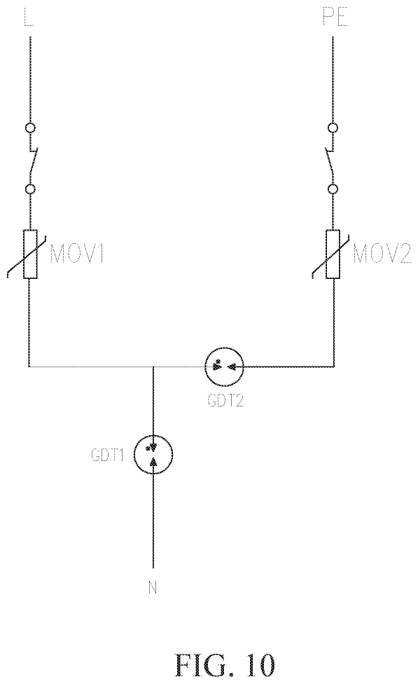

For ease of production, the protective circuit includes three modules that are respectively arranged in the discharge tube unit 2, the first varistor unit 3 and the second varistor unit 4. As shown by the circuit diagram in FIG. 10, the discharge tube unit includes a first discharge tube GDT1 and a second discharge tube GDT2. The first varistor unit includes a first varistor MOV1. The second varistor unit includes a second varistor MOV2. On the first varistor MOV1, a thermal trip is serially connected and the phase electrode L is led out. On the second varistor MOV2, a thermal trip is serially connected and the grounding electrode PE is led out. In the embodiment, the surge protector includes a series circuit for the phase electrode L, the first varistor MOV1, the first discharge tube GDT1 and the neutral electrode N, a series circuit for the first varistor MOV1, the second discharge tube GDT2, the second varistor MOV2 and the grounding electrode PE, and a series circuit for the neutral electrode N, the first discharge tube GDT1, the second discharge tube GDT2, the second varistor MOV2 and the grounding electrode PE.

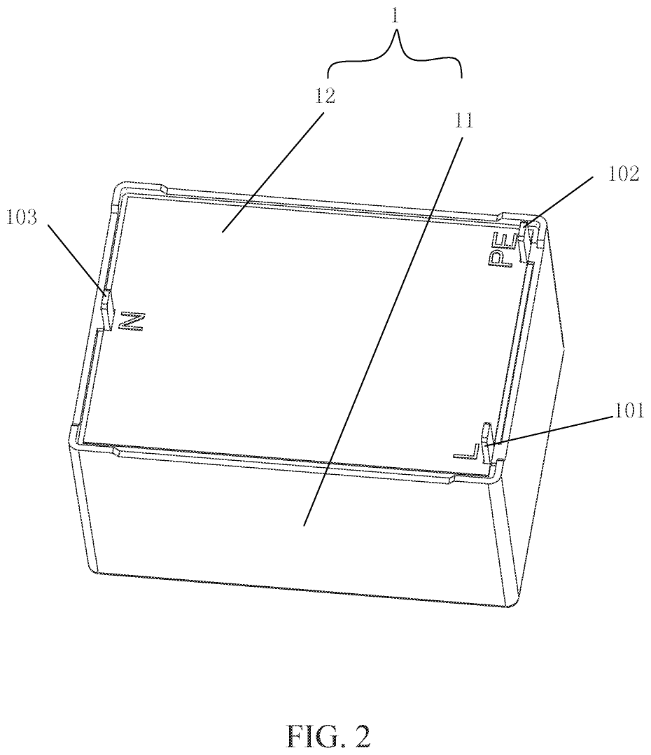

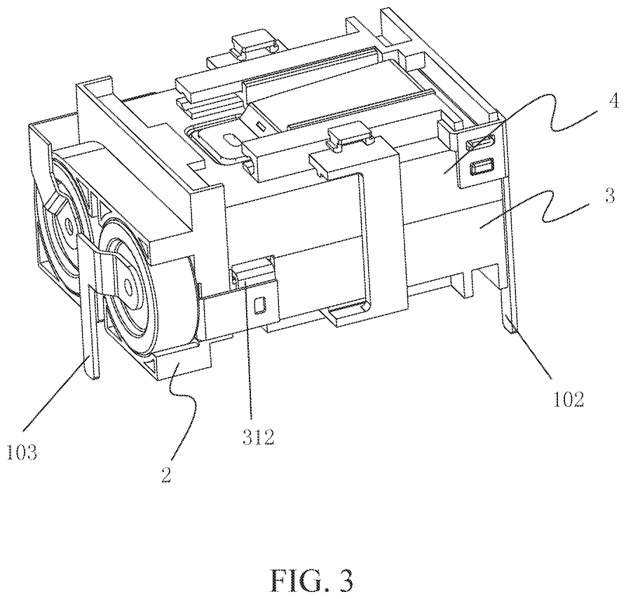

Referring to FIG. 2 to FIG. 6, the discharge tube unit 2 in the embodiment includes a first discharge tube 21 and a second discharge tube 22. The first varistor unit 3 includes a first varistor 31. The first electrode 101 is led out from a positive electrode of the first varistor 31. The second varistor unit 4 includes a second varistor 41. The second electrode 102 is led out from a positive electrode of the second varistor 41. The first discharge tube 21 and the second discharge tube 22 are diode discharge tubes and connected through a discharge tube common electrode. The discharge tube common electrode is electrically connected to a back electrode of the first varistor 31, a back electrode of the second varistor 41 is connected to a back electrode of the second discharge tube 22, and the third electrode 103 is led out from the first discharge tube 21. Referring to FIG. 3 to FIG. 9, the first varistor unit 3 further includes a first frame 32 and a first thermal trip 33. The first thermal trip 33 and the first varistor 31 are respectively arranged at two sides of the first frame 32. The first electrode 101 is led out from the positive electrode of the first varistor 31 through the first thermal trip 33. The first thermal trip 33 includes a spring electrode 331, a sliding member 332 and a compression spring 333. The spring electrode 331 and the positive electrode 311 of the first varistor 31 are connected at an opening 322 through a fusible alloy. The spring electrode 331 abuts against the sliding member 332 and keeps the compression spring 333 in a compressed state. In a failure state, the fusible alloy is molten, the sliding member 332 slides along a guide track 321 on the first frame 32 under an action of the compression spring 333 such that the spring electrode is isolated from the positive electrode of the corresponding varistor, and a side of the sliding member 332 extends outward to form an indication portion 3320. The spring electrode 331 extends outward to form a pin electrode, namely the first electrode. The first varistor and the second varistor are arranged between the first frame and a second frame. A clapboard 5 is provided between the first varistor and the second varistor. The back electrode of the first varistor 31 is led out from a sidewall of the frame to form a welding point 312.

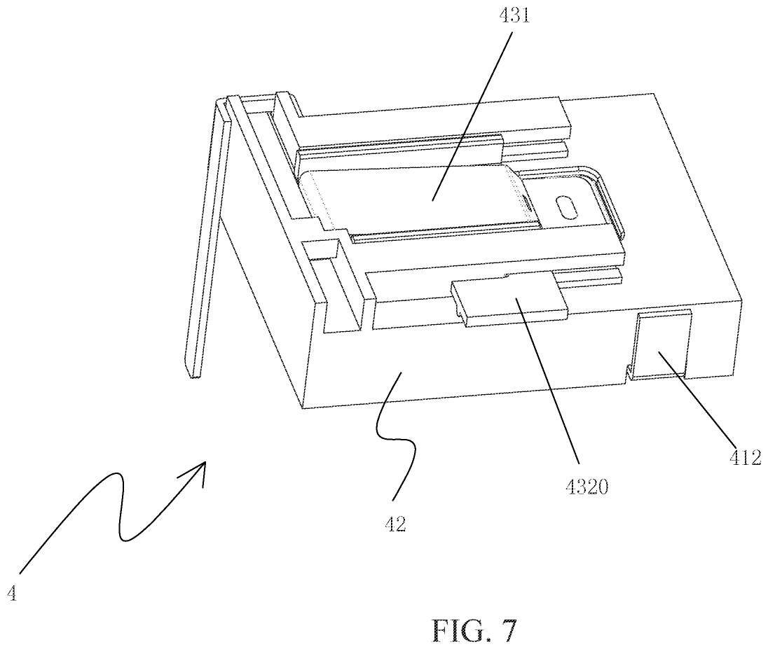

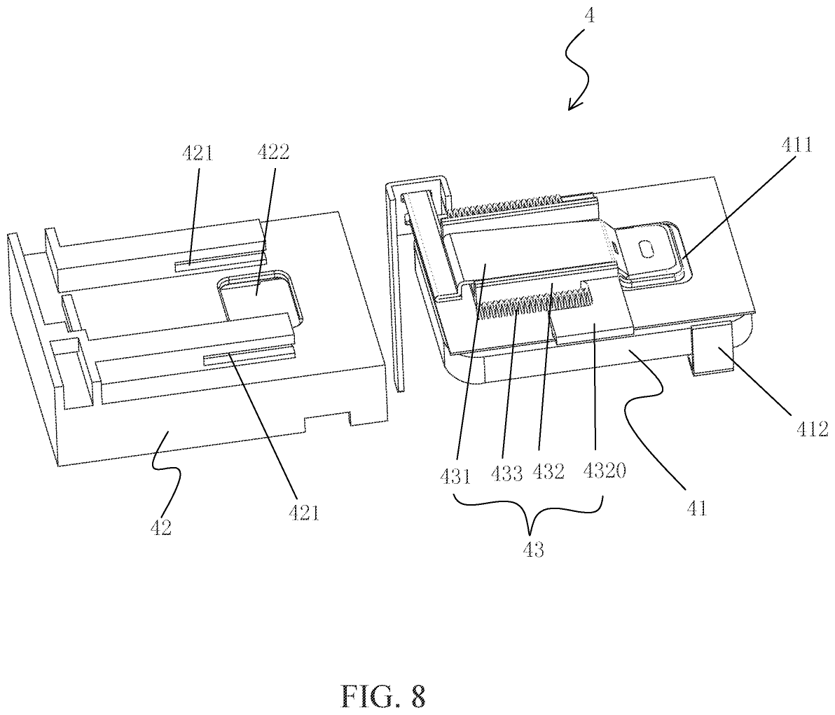

Referring to FIG. 7 and FIG. 8, the second varistor unit 4 further includes a second frame 42 and a second thermal trip 43. The second thermal trip 43 and the second varistor 41 are respectively arranged at two sides of the second frame 42. The second electrode is led out from the positive electrode of the second varistor 41 through the second thermal trip 43. The second thermal trip 43 includes a spring electrode 431, a sliding member 432 and a compression spring 433. The spring electrode 431 and the positive electrode 411 of the second varistor 41 are connected at an opening 422 through a fusible alloy. The spring electrode 431 abuts against the sliding member 432 and keeps the compression spring 433 in a compressed state. In a failure state, the fusible alloy is molten, the sliding member 432 slides along a guide track 421 on the second frame 42 under an action of the compression spring such that the spring electrode 431 is isolated from the positive electrode of the varistor, and a side of the sliding member is formed into an indication portion 4320. The spring electrode 431 is led out through the second electrode 102. The back electrode of the second varistor 41 is led out from a sidewall of the frame to form a welding point 412.

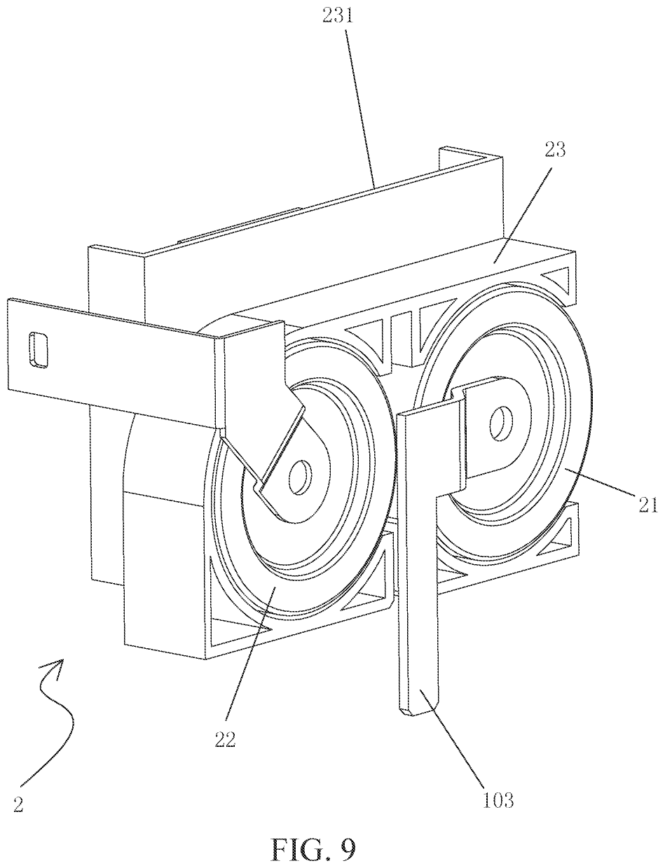

Referring to FIG. 3 and FIG. 9, the discharge tube unit 2 in the embodiment further includes a discharge tube frame 23. A first slot, a second slot and a third slot 231 are formed in the discharge tube frame 23. The first slot and the second slot are provided side by side at a side of the discharge tube frame and respectively configured to accommodate the first discharge tube 21 and the second discharge tube 22. The third slot 231 is provided at a side of the discharge tube frame and cooperates with an end portion of each of the first varistor unit 3 and the second varistor unit 4. The first varistor unit 3 and the second varistor unit 4 are horizontally stacked. The first discharge tube 21 and the second discharge tube 22 are vertically provided.

In the embodiment of the present invention, three frames are provided for the discharge tubes and the varistors to form the modular design. Particularly, the discharge tube unit is provided independently and cooperated with the varistor units. With the vertical discharge tubes and the horizontal varistors, the surge protector has the high assembly efficiency, and meets the requirements of miniaturization applications.

The above descriptions are merely embodiments based on the technical contents of the present invention. Any modifications and changes made by the person skilled in the art based on the present invention should fall within the scope of the present invention, and the present invention is not limited to the above embodiments.

The apparatus embodiment described above is merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. The person of ordinary skill in the art can understand and implement the embodiments without creative efforts.

The term “one embodiment”, “embodiment” or “one or more embodiments” mentioned herein means that a specific feature, structure, or characteristic described in combination with the embodiment is included in at least one embodiment of the present invention. In addition, it should be noted that the phrase example “in an embodiment” herein does not necessarily refer to the same embodiment.

In the specification provided herein, a large number of specific details are described. However, it is to be understood that the embodiments of the present invention can be practiced without these specific details. In some embodiments, well-known methods, structures and techniques are not shown in detail to avoid obscuring the understanding of this specification.

In the claims, any reference sign between brackets should not be constructed as a limitation on the claims. The word “include” does not exclude the presence of elements or steps not listed in the claims. The word “one” or “a/an” preceding an element does not exclude the existence of multiple such elements. The present invention can be implemented with the assistance of hardware including several different components and the assistance of a properly programmed computer. In the unit claims where several apparatuses are listed, several of the apparatuses may be embodied by the same hardware item. The use of words such as first, second, and third do not indicate any order. The words may be interpreted as names.

Finally, it should be noted that the foregoing embodiments are used only to explain the technical solutions of the present invention, but are not intended to limit the present invention. Although the present invention has been described in detail with reference to the foregoing embodiments, the person of ordinary skill in the art should understand that they can still modify the technical solutions described in the foregoing embodiments, or make equivalent substitutions on some or all technical features therein. The modifications or substitutions do not make the essence of the corresponding technical solutions deviate from the spirit and scope of the technical solutions of the embodiments of the present invention.

What is claimed is:

1. A modular surge protector, comprising a shell, a discharge tube unit, a first varistor unit and a second varistor unit, wherein the discharge tube unit, the first varistor unit and the second varistor unit are arranged in the shell; the first varistor unit and the second varistor unit are stacked, the discharge tube unit is provided at a same side of each of the first varistor unit and the second varistor unit, a first electrode is led out from the first varistor unit, a second electrode is led out from the second varistor unit, and a third electrode is led out from the discharge tube unit.

2. The modular surge protector according to claim 1, wherein the discharge tube unit comprises a first discharge tube and a second discharge tube, the first varistor unit comprises a first varistor, the first electrode is led out from a positive electrode of the first varistor, the second varistor unit comprises a second varistor, and the second electrode is led out from a positive electrode of the second varistor;
the first discharge tube and the second discharge tube are connected through a discharge tube common electrode, the discharge tube common electrode is electrically connected to a back electrode of the first varistor, a back electrode of the second varistor is connected to a back electrode of the second discharge tube, and the third electrode is led out from the first discharge tube; and
the first electrode is a phase electrode, the second electrode is a grounding electrode, and the third electrode is a neutral electrode.

3. The modular surge protector according to claim 1 or 2, wherein the first varistor unit comprises a first frame and a first thermal trip, the first thermal trip and the first varistor are respectively arranged at two sides of the first frame, and the first electrode is led out from the positive electrode of the first varistor through the first thermal trip;
the second varistor unit comprises a second frame and a second thermal trip, the second thermal trip and the second varistor are respectively arranged at two sides of the second frame, and the second electrode is led out from the positive electrode of the second varistor through the second thermal trip; and
the first varistor and the second varistor are arranged between the first frame and the second frame.

4. The modular surge protector according to claim 1, wherein the first varistor unit and the second varistor unit are clamped by a clamping member.

5. The modular surge protector according to claim 3, wherein each of the first thermal trip and the second thermal trip comprises a spring electrode, a sliding member and a compression spring, wherein
the spring electrode is connected to a positive electrode of a corresponding varistor through a fusible alloy;
the spring electrode abuts against the sliding member and keeps the compression spring in a compressed state; and
in a failure state, the fusible alloy is molten, the sliding member slides along a guide track on the first frame or the second frame under an action of the compression spring, wherein the spring electrode is isolated from the positive electrode of the corresponding varistor, and a side of the sliding member extends outward to form an indication portion.

6. The modular surge protector according to claim 5, wherein the spring electrode of the first thermal trip and the positive electrode of the first varistor are connected at an opening through the fusible alloy.

7. The modular surge protector according to claim 5, wherein the spring electrode of the second thermal trip and the positive electrode of the second varistor are connected at an opening through the fusible alloy.

8. The modular surge protector according to claim 6, wherein the back electrode of the first varistor is led out from a sidewall of the first frame to form a welding point.

9. The modular surge protector according to claim 7, wherein the back electrode of the second varistor is led out from a sidewall of the second frame to form a welding point.

10. The modular surge protector according to claim 1, wherein the discharge tube unit comprises a discharge tube frame;
a first slot, a second slot and a third slot are formed in the discharge tube frame;
the first slot and the second slot are provided side by side at a side of the discharge tube frame, and the first slot and the second slot are respectively configured to accommodate the first discharge tube and the second discharge tube;
the third slot is provided at a side of the discharge tube frame, and the third slot cooperates with an end portion of each of the first varistor unit and the second varistor unit;
the first varistor unit and the second varistor unit are horizontally stacked; and
the first discharge tube and the second discharge tube are vertically provided.

11. The modular surge protector according to claim 1, wherein the shell comprises a shell body and an engageable cover plate, and the first electrode, the second electrode and the third electrode are led out from a side of a cover plate to form a welding plate structure.

12. The modular surge protector according to claim 2, wherein the first varistor unit comprises a first frame and a first thermal trip, the first thermal trip and the first varistor are respectively arranged at two sides of the first frame, and the first electrode is led out from the positive electrode of the first varistor through the first thermal trip;
the second varistor unit comprises a second frame and a second thermal trip, the second thermal trip and the second varistor are respectively arranged at two sides of the second frame, and the second electrode is led out from the positive electrode of the second varistor through the second thermal trip; and
the first varistor and the second varistor are arranged between the first frame and the second frame.

13. The modular surge protector according to claim 2, wherein the discharge tube unit comprises a discharge tube frame;
a first slot, a second slot and a third slot are formed in the discharge tube frame;
the first slot and the second slot are provided side by side at a side of the discharge tube frame, and the first slot and the second slot are respectively configured to accommodate the first discharge tube and the second discharge tube;
the third slot is provided at a side of the discharge tube frame, and the third slot cooperates with an end portion of each of the first varistor unit and the second varistor unit;
the first varistor unit and the second varistor unit are horizontally stacked; and
the first discharge tube and the second discharge tube are vertically provided.

14. The modular surge protector according to claim 5, wherein the discharge tube unit comprises a discharge tube frame;
a first slot, a second slot and a third slot are formed in the discharge tube frame;
the first slot and the second slot are provided side by side at a side of the discharge tube frame, and the first slot and the second slot are respectively configured to accommodate the first discharge tube and the second discharge tube;
the third slot is provided at a side of the discharge tube frame, and the third slot cooperates with an end portion of each of the first varistor unit and the second varistor unit;
the first varistor unit and the second varistor unit are horizontally stacked; and
the first discharge tube and the second discharge tube are vertically provided.

15. The modular surge protector according to claim 5, wherein two indication windows cooperated with the indication portion of the sliding member are formed in the shell.

16. The modular surge protector according to claim 2, wherein a clapboard is provided between the first varistor and the second varistor.
